(19) United States
(12) Patent Application Publication
(10) Pub. No.: US 2024/0205065 A1
(43) Pub. Date: Jun. 20, 2024

(54) ULTRA WIDE BAND SIGNALS USING ORTHOGONAL TIME FREQUENCY SPACE MODULATION

(71) Applicant: Cohere Technologies, Inc., San Jose, CA (US)

(72) Inventors: Shlomo Selim Rakib, San Jose, CA (US); Ronny HADANI, San Jose, CA (US); Shachar KONS, San Jose, CA (US); Clayton AMBROSE, San Jose, CA (US)

(21) Appl. No.: 18/555,391

(22) PCT Filed: Apr. 29, 2022
(86) PCT No.: PCT/US2022/072002

§ 371 Date: Oct. 13, 2023

Related U.S. Application Data
(60) Provisional application No. 63/181,828, filed on Apr. 29, 2021.

(51) Int. Cl. H04L 27/26; H04L 27/10

(52) U.S. Cl. CPC H04L 27/2639; H04L 27/103; H04L 27/2628

(57) ABSTRACT

Methods, systems and devices for wireless communication are described. One example method includes mapping information bits to transmission resources in a two-dimensional delay-Doppler grid In this example, the two-dimensional delay-Doppler grid includes N Doppler elements along a Doppler dimension and M delay elements along a delay dimension, and N and M are positive integers. The example method continues with converting a result of the mapping to a signal waveform, and generating an orthogonal time frequency space (OTFS) waveform by spreading the signal waveform using a spreading scheme. In some examples, the signal waveform includes an ultra-wide band (UWB) waveform.

### CROSS-REFERENCE TO RELATED APPLICATION(S)

This application claims priority to U.S. Provisional Application No. 63/181,828, filed on Apr. 29, 2021, titled “ULTRA WIDE BAND SIGNALS USING ORTHOGONAL TIME FREQUENCY SPACE MODULATION,” the disclosure of which is hereby incorporated by reference herein in its entirety.

### TECHNICAL FIELD

The present document relates to wireless communication.

### BACKGROUND

Due to an explosive growth in the number of wireless user devices and the amount of wireless data that these devices can generate or consume, current wireless communication networks are fast running out of bandwidth to accommodate such a high growth in data traffic and provide high quality of service to users.

Various efforts are underway in the telecommunication industry to come up with next generation of wireless technologies that can keep up with the demand on performance of wireless devices and networks. Many of those activities involve situations in which a large number of user devices may be served by a network.

### SUMMARY

This document discloses techniques that may be used by wireless networks to achieve several operational improvements.

In one example aspect, a wireless communication method is disclosed. The method includes mapping information bits to transmission resources in a two-dimensional delay-Doppler grid, wherein the two-dimensional delay-Doppler grid comprises N Doppler elements along a Doppler dimension and M delay elements along a delay dimension, where N and M are positive integers; converting a result of the mapping to a signal waveform; and generating an orthogonal time frequency space (OTFS) waveform by spreading the signal waveform using a spreading scheme.

In another example aspect, another wireless communication method is disclosed. The method includes determining an estimate of a signal waveform received at a receiver by de-spreading an orthogonal time frequency space (OTFS) waveform using a de-spreading scheme; obtaining a two-dimensional delay-Doppler grid representation from the signal waveform; and extracting information bits from the two-dimensional delay-Doppler grid representation.

In another example aspect, a wireless communication apparatus that implements the above-described methods is disclosed.

In yet another example aspect, a wireless system in which one or more of the above described methods are implemented is disclosed.

In yet another example aspect, the method may be embodied as processor-executable code and may be stored on a computer-readable program medium.

In yet another aspect, a wireless communication system that operates by providing a single pilot tone for channel estimation is disclosed.

These, and other, features are described in this document.

### DESCRIPTION OF THE DRAWINGS

Drawings described herein are used to provide a further understanding and constitute a part of this application. Example embodiments and illustrations thereof are used to explain the technology rather than limiting its scope.

FIG. 1A shows an example communication network.

FIG. 1B shows a simplified example of a wireless communication system in which uplink and downlink transmissions are performed.

FIG. 2 shows an example mathematical model used to model communication in the wireless communication system of FIG. 1A.

FIG. 3 depicts an example of an end-to-end wireless system implementation, at least partly using OTFS technology.

FIG. 4 shows an example of a delay-Doppler plan in which symbols that contain information bits rate show.

FIG. 5 pictorially depicts the concept of twisted convolution.

FIG. 6 shows example of superiority of OTFS modulation at high mobility.

FIG. 7 shows an example of multi-user multiplexing in an OTFS communication system.

FIG. 8A pictorially depicts an example arrangement of pulses in an OTFS waveform.

FIG. 8B shows an example of an OTFS waveform.

FIG. 9 depicts an example of use of a filter bank for generating a transmission waveform.

FIG. 10 shows mathematical relationships among various transmission parameters.

FIG. 11 shows time domain representation of an OTFS transmission waveform.

FIG. 12 shows an example of a spreading scheme.

FIG. 13A to 13D show examples of frequency responses of filters used for processing a transmission waveform.

FIG. 14 shows an example of spreading time frequency pulses in frequency domain to generate an ultrawideband signal.

FIG. 15 shows an example of localization properties of a transmission waveform in delay-Doppler domain.

FIG. 16A shows an example of a transmission method in which a delay-Doppler grid is transformed to a time-frequency grid using a Symplectic Fast Fourier Transform (SFFT).

FIG. 16B shows an example of a transmission method in which a delay-Doppler grid is transformed to a time-frequency sub-grid.

FIG. 16C shows an example of transmission method in which a delay-Doppler grid is transformed to an OTFS waveform using a Zak transform over the Doppler dimension.

FIG. 16D shows an example of a reception method in which Inverse SFFT (ISFFT) is used to recover information bits from a received waveform.

FIG. 16E shows an example of a reception method in which Inverse SFFT (ISFFT) is used to recover information bits from an OTFS sub-grid of a received waveform.

FIG. 16F shows an example of a reception method in which an inverse Zak transform over the time dimension is used to recover information bits from a received waveform.

FIG. 17 pictorially depicts relationship between time, frequency and Zak domains.

FIG. 18 pictorially depicts an example wherein the Zak domain and time/frequency Zak transforms realizing the signal space realization lie in between time and frequency realizations.

FIG. 19 shows an example of a hardware platform.

FIGS. 20-21 are flowcharts for various example methods of wireless communication.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Furthermore, certain standard-specific terms are used for illustrative purpose only, and the disclosed techniques are applicable to any wireless communication systems.

### 1. Introduction—Wireless Communication Environment

The wireless or time-variant nature of the communication channel poses several challenges in design a transmission protocol suitable for wireless communication scenarios. These days, users expect their wireless devices to work everywhere and in a variety of mobile or stationary situations.

The relative movement of transmitters and receivers with respect to each other cause signal distortions such as varying channel delay, Doppler and/or angular spread, signal degradation due to ground clutter, sea clutter, and so on. Another example of signal degradation is flat fading in which an entire channel occupied by a transmission signal experiences fading or attenuation that may be relatively constant across the channel. In practice, a transmission scheme may need to be designed to fit within a certain link budget, maximum power constraint, or linearity of electronics used for transmitting or receiving signals.

Furthermore, a communications system may perform transmissions between a transmitter and one or more receivers using various configurations such as ad-hoc (any device to any device), or multi-user (one device to many devices). Recently, a technique called orthogonal time frequency space (OTFS) modulation has been introduced to address such problems, and others. A brief overview of the OTFS technology is provided in the present document.

One additional desirable feature of communications systems is its security aspect. For example, users and network operators may prefer communications scheme that offer low probability of intercept and inherently provide secure communication by reducing or eliminating probability of detectability or eavesdropping on the communication. Another security aspect is being able to avoid interference or jamming of communication signals. A class of transmission schemes, generally called ultra-wide band (UWB) modulation, provides such security features for signal transmissions. In a typical UWB scheme, a transmission signal is spread over a large frequency band (e.g., upwards of 200 MHz or 1 GHz), such that each frequency carries a very small amount of transmitted information and low power. Such a transmission is therefore undetectable using typical signal detection techniques and furthermore provides robustness against interference that degrades transmission quality at certain frequencies. The present document provides a brief overview of the UWB technology.

While OTFS and UWB schemes provide significant performance improvements with respect to certain desirable aspects of a signal communication scheme, to date, no scheme is known that combines the beneficial features of both OTFS and UWB technologies. The present document provides techniques that can be incorporated into transmitter and receiver technologies for transmitting or receiving a signal using a transmission scheme that combines OTFS and UWB techniques.

### 2. Example Wireless Systems

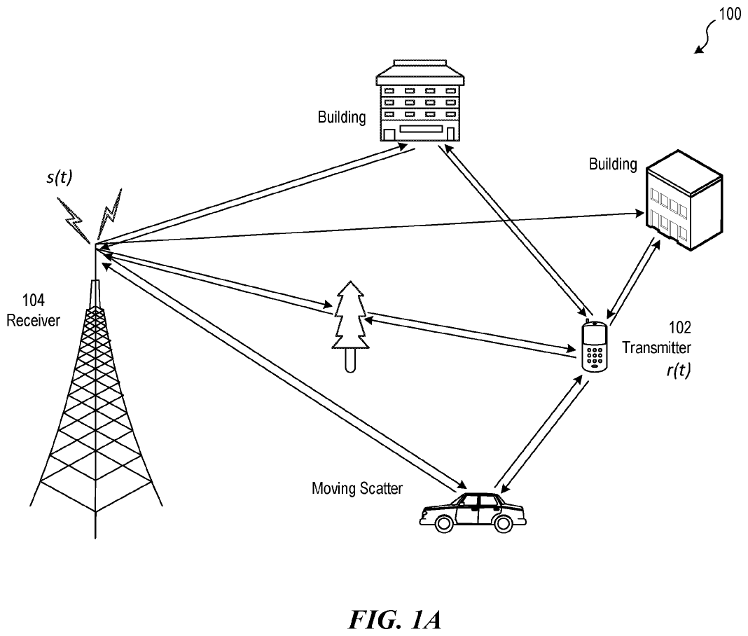

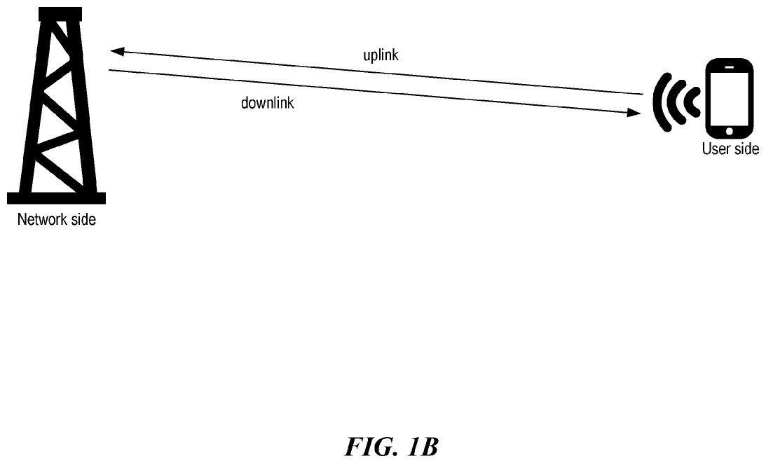

FIG. 1A shows an example of a wireless communication system 100 in which a transmitter device 102 transmits signals to a receiver 104. The signals may undergo various wireless channels and multipaths, as depicted. Some reflectors such as buildings and trees may be static, while others such as cars, may be moving scatterers. The transmitter device 102 may be, for example, a user device, a mobile phone, a tablet, a computer, or another Internet of Things (IoT) device such as a smartwatch, a camera, and so on. The receiver device 104 may be a network device such as the base station. The signals transmitted from the base station to the transmitter 102 may experience similar channel degradations produced by static or moving scatterers. The techniques described in the present document may be implemented by the devices in the wireless communication system 100. The terms “transmitter” and “receiver” are simply used for convenience of explanation and, as further described herein, depending on the direction of transmission (uplink or downlink), the network station may be transmitting or receiving and user device may be receiving or transmitting.

FIG. 1B shows a simplified wireless network to highlight certain aspects of the disclosed technology. A transmitter transmits wireless signals to a receiver in the wireless network. Some transmissions in the network, variously called as downlink or downstream transmissions, a network-side node such as a base station acts as a transmitter of wireless signals and one or more user devices act as the receiver of these wireless signals. For some other transmissions, as depicted in FIG. 1B, the direction of transmission may reversed. Such transmissions are often called uplink or upstream transmissions. For such transmissions, one or more user devices act as transmitters of the wireless signals and a network-side node such as the base station acts as the receiver of these signals (as depicted in FIG. 1B). Other type of transmissions in the network may include device-to-device transmissions, sometimes called direct or sideband transmissions. While the present document primarily uses the terms “downlink” and “uplink” for the sake of convenience, similar techniques may also be used for other situations in which transmissions in two directions are performed—e.g., inbound or incoming transmissions that are received by a wireless device and outbound or outgoing transmissions that are transmitted by a wireless device. For example, downlink transmissions may be inbound transmissions for a user device, while outbound transmissions for a network device. Similarly, uplink transmission may be inbound transmissions for a network device while outbound transmissions from a wireless device. Therefore, for some embodiments, the disclosed techniques may also be described using terms such as “inbound” and “outbound” transmission without importing any 3GPP-specific or other wireless protocol-specific meaning to the terms “uplink” and “downlink.”

In frequency division multiplexing (FDM) networks, the transmissions to a base station and the transmissions from the base station may occupy different frequency bands (each of which may occupy continuous or discontinuous spectrum). In time division multiplexing (TDM) networks, the transmissions to a base station and the transmissions from the base station occupy a same frequency band but are separated in time domain using a TDM mechanism such as time slot based transmissions. Other types of multiplexing are also possible (e.g., code division multiplexing, orthogonal time frequency space, or OTFS, multiplexing, spatial multiplexing, etc.). In general, the various multiplexing schemes can be combined with each other. For example, in spatially multiplexed systems, transmissions to and from two different user devices may be isolated from each other using directional or orientational difference between the two end points (e.g., the user devices and a network station such as a base station).

### 3. Brief Introduction to OTFS

The orthogonal time frequency space (OTFS) method is based at least in part upon the realization that in many cases various advantages may accrue from spreading the data of a single symbol over multiple time-spreading intervals shared with other symbols. In contrast with prior art modulation techniques, the OTFS method may involve convolving a single data symbol over both a plurality of time slots, a plurality of frequencies or spectral regions (spread spectrum), and a plurality of spectral shapes. This approach to data convolution results in superior performance over impaired communications links.

In one aspect, and as is indicated below by Equation (1), the OTFS method recognizes that a wireless channel may be represented as a weighted superposition of combination of time and Doppler shifts:

$${h}^{a} ( φ ) ( t ) = {\sum }_{τ , u} a ( τ , u ) {e}^{j 2 π ut} φ ( t + τ ) \qquad ( 1 )$$

In contrast to parameters associated with existing channel models, the time-frequency weights (τ, u) of Equation (1) are two-dimensional and are believed to fully characterize the wireless channel. The time-frequency weights (τ, u) are intended to represent essentially all of the diversity branches existing in the wireless channel. This is believed to substantially minimize the fading effects experienced by the OTFS system and other communication systems generally based upon two-dimensional channel models relative to the fading common in systems predicated upon one-dimensional models. Finally, in contrast to the non-stationary, one-dimensional channel models employed in conventional communication systems, the time-frequency weights (τ, u) of Equation (1) are substantially stationary; that is, the weights change very slowly relative to the time scale of exemplary embodiments of the OTFS system.

Use of the two-dimensional channel model of Equation (1) in embodiments of the OTFS communication system affords a number of advantages. For example, use of the channel model of Equation (1) enables both channel multipath delay and Doppler shift to be accurately profiled simultaneously. Use of this model and the OTFS modulation techniques described herein also facilitate the coherent assembly of channel echoes and the minimization of fading phenomena, since every symbol experience substantially all of the diversity branches present within the channel. Given that the two-dimensional channel model is essentially stationary, every symbol is deterministically distorted (smeared) according to substantially the same two-dimensional pattern. This stable, accurate characterization of the communication channel in two dimensions on an ongoing basis further enables the OTFS system to minimize data distortion by “customizing” how each bit is delivered across the channel. Finally, use of a two-dimensional channel model enables effective signal separation by decoupling and eliminating mutual interference between multiple sources.

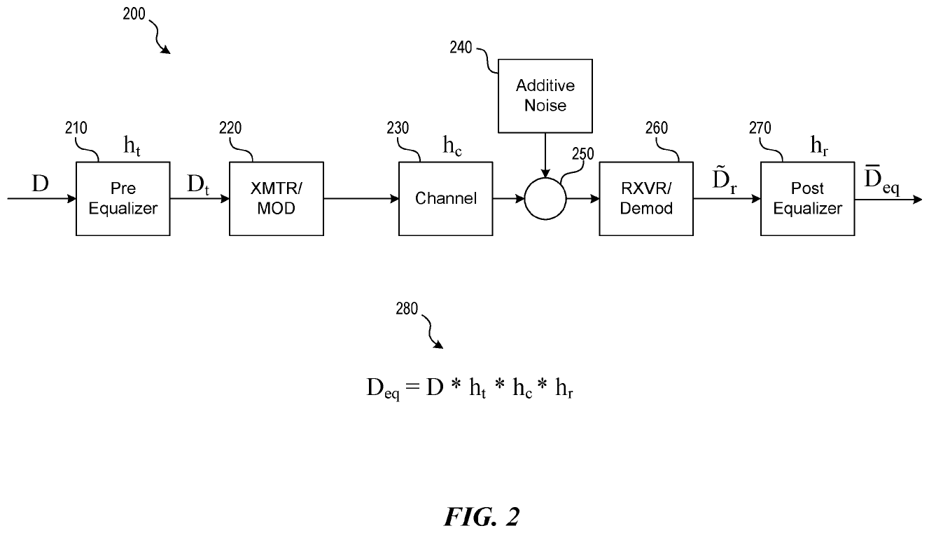

FIG. 2 illustrates an example of a mathematical model 200 that can be used to model time/frequency selective fading. A transmit side of the model 200 includes a pre-equalizer 210, a transmitter/modulation component 220, a channel model 230, and additive noise 240 which is combined with the transmitted signal via a summer 250. A receive side of the model 200 includes a receiver/demodulator 260 and a post equalizer 270.

The pre-equalizer 210 is used to model a pre-distortion transfer function hₜ that can be used to make up for changing channel conditions in the channel model h_{c} based on feedback received over the channel from the receive side of the model, as determined by measurements made by the receiver/demodulator 260 and/or the post equalizer 270. The transmitter/modulator 220 uses modulation schemes described herein to transmit the data over the channel 230.

The receiver/demodulator 260 demodulates the signal received over the channel 230. The received signal has been distorted by time/frequency selective fading, as determined by the channel transfer function h_{c}, and includes the additive noise 240. The receiver/demodulator 260 and the post equalizer 270 utilize methods discussed herein to reduce the distortion caused by the time/frequency selective fading and additive noise due to the channel conditions. The mathematical model 200 can be used to determine the nature of the equalized data D_{eq} by performing a mathematical combination of three transfer functions operating on the original data D. The three transfer functions include the transmitter transfer function hr, the channel transfer function h_{c} and the equalizer transfer function hr.

Embodiments of the OTFS methods and systems described herein are based, in part, upon the realization that spreading the data for any given symbol over time, spectrum, and/or spectral shapes in the manner described herein yields modulated signals which are substantially resistant to interference, particularly interference caused by Doppler effects and multi-path effects, as well as general background noise effects. Moreover, the OTFS method is believed to require less precise frequency synchronization between receiver and transmitter than is required by existing communication systems (e.g., OFDM systems).

In essence, the OTFS method convolves the data for a group of N.sup.2 symbols (herein called a “frame”) over both time, frequency, and in some embodiments spectral shape in a way that results in the data for the group of symbols being sent over a generally longer period of time than in prior art methods. Use of the OTFS method also results in the data for any given group of symbols being accumulated over a generally longer period of time than in prior art methods. However, in certain embodiments the OTFS method may nonetheless enable favorable data rates to be achieved despite the use of such longer transmission periods by exploiting other transmission efficiencies enabled by the method. For example, in one embodiment a group of symbols may be transmitted using the same spread-spectrum code. Although this could otherwise result in confusion and ambiguity (since each symbol would not be uniquely associated with a code), use of the OTFS method may, for example, enable the symbols to be sent using different (but previously defined) spread-spectrum convolution methods across a range of time and frequency periods. As a consequence, when all of the data corresponding to the symbols is finally accumulated within the receiver, the entire frame or group of symbols may be reconstructed in a manner not contemplated by prior art techniques. In general, one trade-off associated with the disclosed approach is that either an entire multi-symbol frame of data will be correctly received, or none of the frame will be correctly received; that is, if there is too much interference within the communication channel, then the ability to successfully deconvolve and retrieve multiple symbols may fail. However, as will be discussed, various aspects of the OTFS may mitigate any degradation in performance which would otherwise result from this apparent trade-off.

For the OTFS model of a channel as described above, the channel can be modeled using a small set of dominant reflectors. Such a representation of the channel provides a concise and robust channel representation that is mathematically less complex (compared to traditional channel acquisition techniques). Furthermore, use of second order statistics allowed for prediction of channel at a different (future) time, or in a different frequency band, based on delay-Doppler domain modeling of a channel. Such a compact model thus allows for robust acquisition, estimation and prediction of channel.

One advantageous aspect of OTFS is the use of second order statistics for channel representation allows for a stationary channel model that does not need to be changed frequently. In some embodiments, a channel may be modeled into a stationary portion and a non-stationary portion that is updated on an occasional basis. Such a model reduced the bandwidth overhead of reference signal and/or feedback signal transmissions. Put differently, the channel state information (CSI) remains relatively static and required less frequent updates than conventional 4G or 5G New Radio (NR) technology.

As further described in the present document, OTFS waveform allows for spreading of information bits across different delay and/or Doppler values, and therefore provides mathematical ability to be invariant to mobility. Furthermore, signal precoding in delay Doppler domain may be used to further achieve efficiency of transmission.

Other advantages of OTFS technology include:
Low Complexity—this may be achieved due to efficient channel modeling (sparse channel representation) that requires infrequent updates
Scheduling—channel characteristics in a different frequency band or at a future time can be predicted with high accuracy, thereby allowing accurate scheduling, including, for example, centralized scheduling in a cooperative network.
Scalable Pairing—user devices may be paired for transmission using scalable transmissions (e.g., beamforming)
Large Number of users & Number of Layers—the use of OTFS based spectral shaping in spatial domain allows for a compact communication scheme that accommodates a large number of user devices.
Backward compatibility—Several of the channel estimation techniques can work without the need of an explicit feedback for spatial multiplexing and therefore can be implemented in networks that include legacy or previous generation device.
Co-existence 4G & 5G—OTFS spectrum can be transmitted using an orthogonal frequency division multiplexing (OFDM) scheme and be made compatible with conventional 4G and 5G technologies.
Cloud-RAN Architecture—due to the ability of OTFS to perform channel estimation using a sparse channel representation and the ability to predict future channels, the channel estimation can be made robust to computational delays. This lends itself to be able to operate a cloud based channel estimation/precoding/scheduling of a radio access network (RAN), in which the backhaul delays for communication of channel estimates do not impact system performance.
Scheduler disaggregation—for a similar reason as above, the scheduling function of a network of cellular communication cells can be controlled using a scheduler that is dis-aggregated from a base station function (radio access) and can be implemented in the cloud.
Joint scheduling and Coordinated multisite—as described above, the joint scheduling of cells using a disaggregated or a cloud based scheduler allows for efficient use of spectrum within a cell and more particularly in overlapping areas of different cells.
Analytics—the cloud-based architecture that collects channel state feedback from different user devices in different cells allows for generation of analytics in which user device locations, network topology and other information about a network can be extracted for further robust operation of a wireless network.
CoMP—Cooperative Multi-Point operation of base stations is possible using the above-described scheduler aggregation and cloud-RAN techniques.

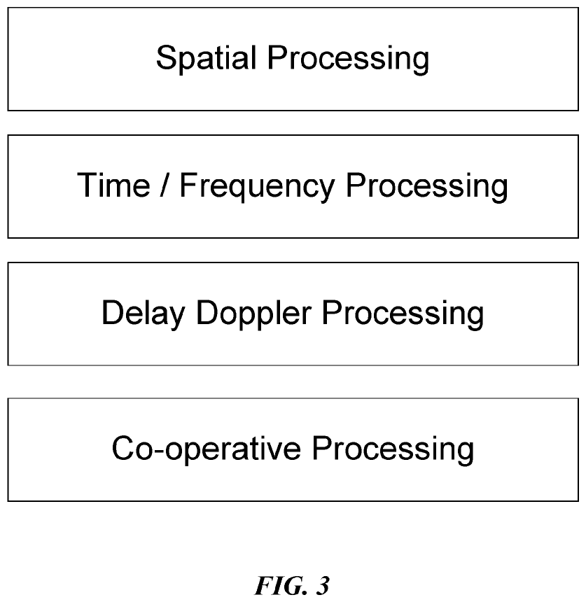

FIG. 3 depicts an example of an end-to-end wireless system implementation, at least partly using OTFS technology. As described above, various beneficial aspects include enablement of cooperative processing, channel estimation/equalization in delay Doppler domain, ability to provide additional control in time/frequency domain and spatial processing to form layered communication to increase density of devices in a cell.

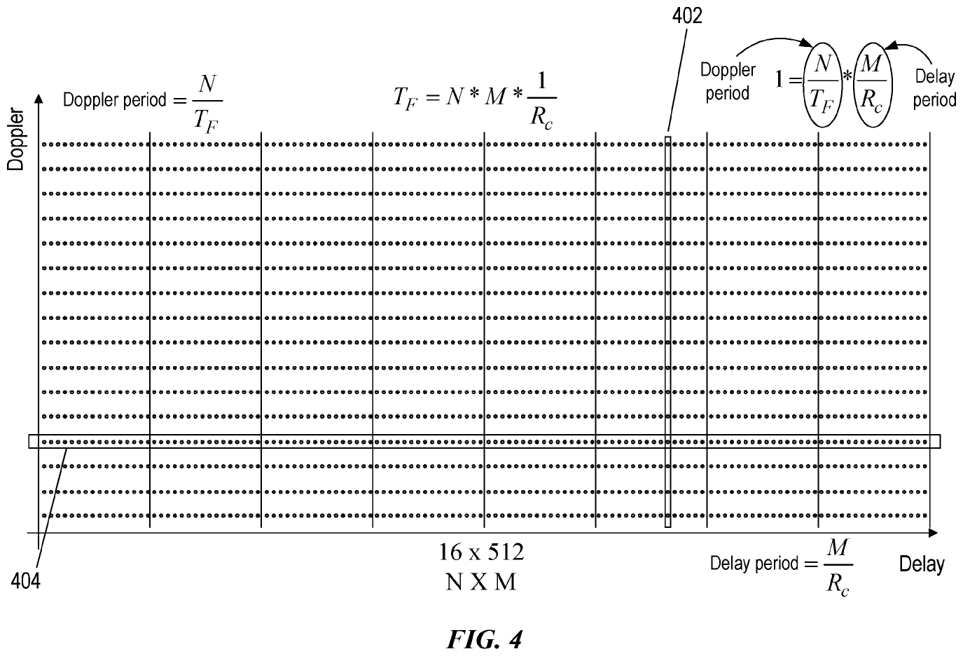

FIG. 4 shows an example of a delay Doppler plane in which symbols that contain information bits are shown. In FIG. 4, the horizontal axis is the delay axis and the vertical axis is Doppler axis. Each dot in the graphs shows a modulation symbol that comprises information bits. One example of a symbol 402 in the delay domain is shown by a tall rectangle that comprises all modulated bits having a same delay, but different Doppler values. The example depicted in FIG. 4 shows a delay-Doppler grid where N=16 (elements along Doppler direction) and M=512 (elements along delay direction). In this document, a delay-Doppler element can be equivalently represented by a delay-Doppler coordinate. Without a loss of generalization, the coordinate for an element can be assumed to be the center of the element. Herein, the delay resolution is reciprocal of channel bandwidth, and the Doppler resolution is inversely proportional to the frame time used for the communication.

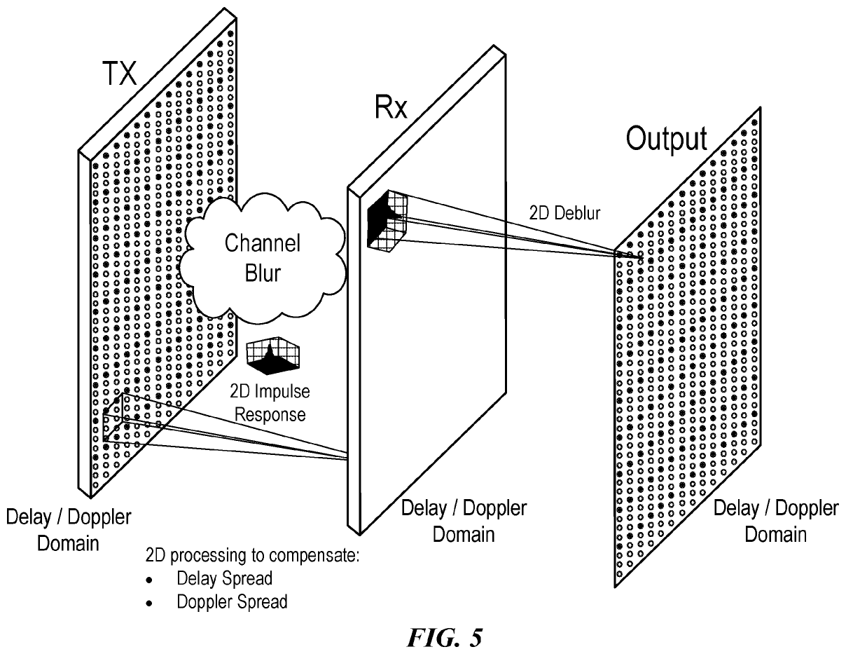

FIG. 5 pictorially depicts the concept of twisted convolution. Starting from left to right, the two-dimensional arrangement of symbols in the delay-Doppler domain is depicted on the transmitter side. During transmission from the transmitter TX to a receiver Rx, the signal may get blurred or distorted based on a 2D impulse response of the channel. This alteration is depicted as channel blur. The received signal in the delay Doppler domain may be recovered using deblurring to obtain estimates of the transmitted symbols. The end-to-end process is considered to include twisted convolution due to the changes in delay-Doppler position of the transmission waveform.

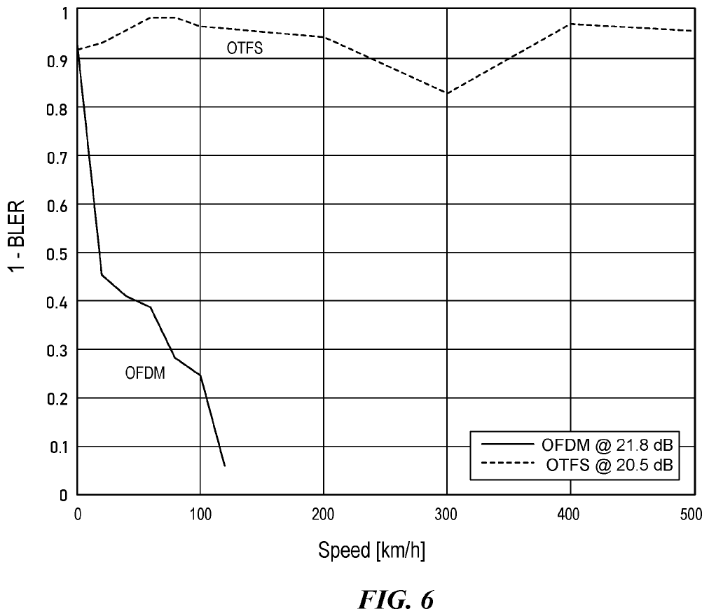

FIG. 6 is a graph showing superiority of OTFS technology over the traditional orthogonal frequency division multiplexing (OFDM) technology. As shown in the graph, the measure of (1-BLER), which is proportional to the throughput (vertical axis) of OTFS modulation is relatively flat across relative mobility between a transmitter and a receiver (horizontal axis showing speed differential). As can be seen from the graph, conventional OFDM technology fails to cope up with Doppler degradation that exceeds 100 to 120 km per hour, while OTFS modulated signals can be successfully received without significant degradation in throughput.

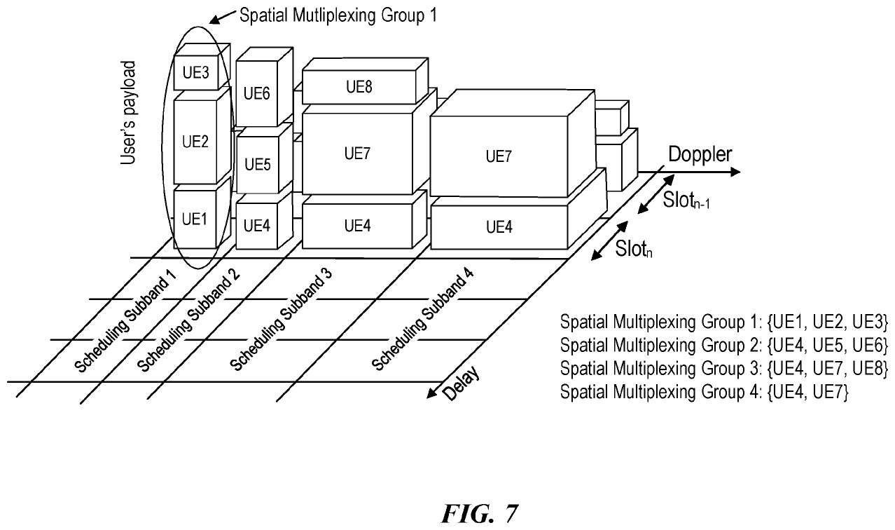

FIG. 7 shows an example of multi-user multiplexing using delay-Doppler transmission resources. Information bit traffic from various users (or user devices) may be multiplexes along the Doppler dimension and the delay dimension, and furthermore spatially multiplexed to achieve greater transmission bandwidth use. For example, spatial multiplexing group 1 may include traffic for three user devices—UE1, UE2 and UE3, that are spatially multiplexed and occupy same delay/Doppler resources. In this context, the Doppler domain is divided into subbands while the delay domain is divided into delay slots (or time slots) for multiplexing.

### 4. OTFS and UWB

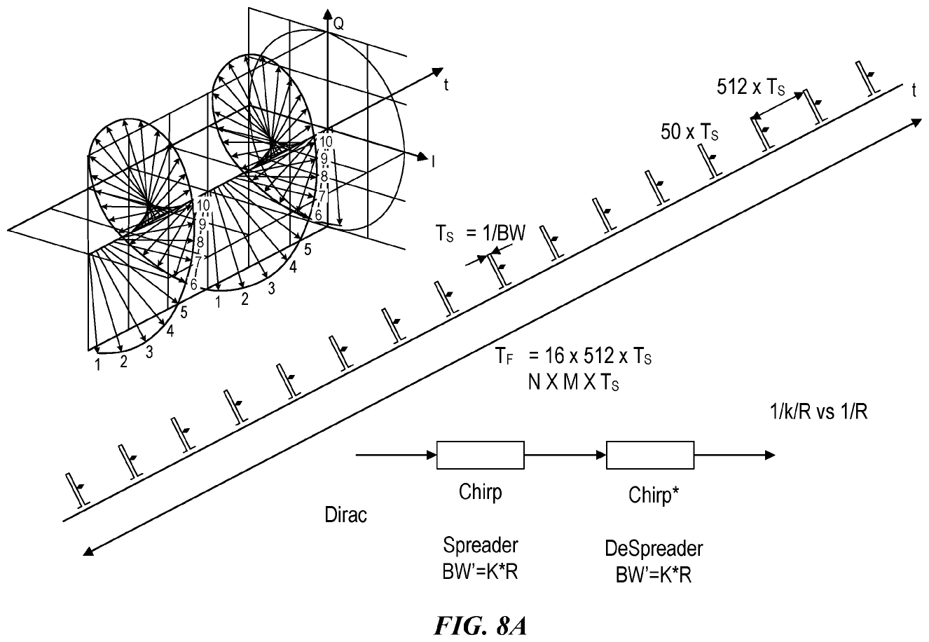

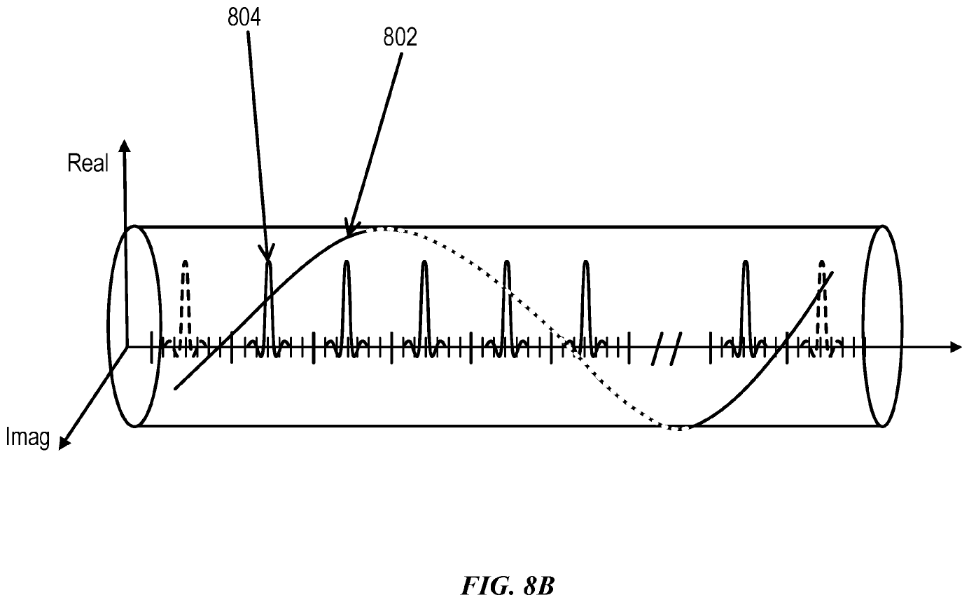

FIG. 8A pictorially depicts an example arrangement of pulses in an OTFS modulation scheme. As shows along the 2D plot of I and Q axes (horizontal and vertical) as signal transmissions progress along the time axis, the phase vector is shown to make a rotation along I-Q axis as the phase of the pulses advances through the frame. The time pulses corresponding to the delay-Doppler domain symbols with the dashed line underneath the pulse depicting the underlying 512 delay elements. The time pulses can be considered as Dirac delta functions and passed through a chirp function that causes the energy to spread in a bandwidth that corresponds to K*R dilation. At the receiver side, the signal may be passed through an inverse chirp processing despreader to generate an estimate of the transmitted signal.

FIG. 8B shows another depiction of an OTFS waveform. As depicted, an OTFS waveform can be conceptually considered to comprise time-localized pulses (804) that are frequency localized due to modulation from a phase function (802) which modifies the pulses along time axis.

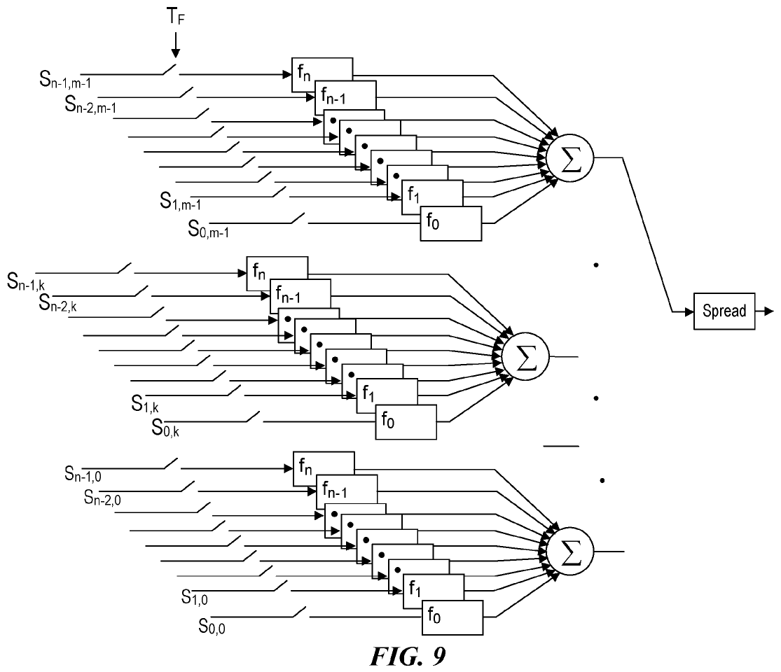

FIG. 9 depicts an example of use of a filter bank for generating a transmission waveform from pulses of the OTFS waveform. As depicted in the figure, successive pulses may be processed through filter functions f₀ to fₙ₋₁, which map the pulses to a predetermined frequency band, followed by a summation of the resulting frequency mapped signal. The resulting signal is spread using a spreading technique which may include using chirp spread spectrum to generate an UWB signal. In some embodiments, an UWB signal may be generated using direct chaos communication (DCC) scheme. In some embodiments, a pseudo-noise based UWB signal generation technique may be used. In some embodiments, frequency hopping may be used generate the output signal waveform. Other techniques for spreading the resulting transmission waveform in time and/or frequency domain may be used in other embodiments.

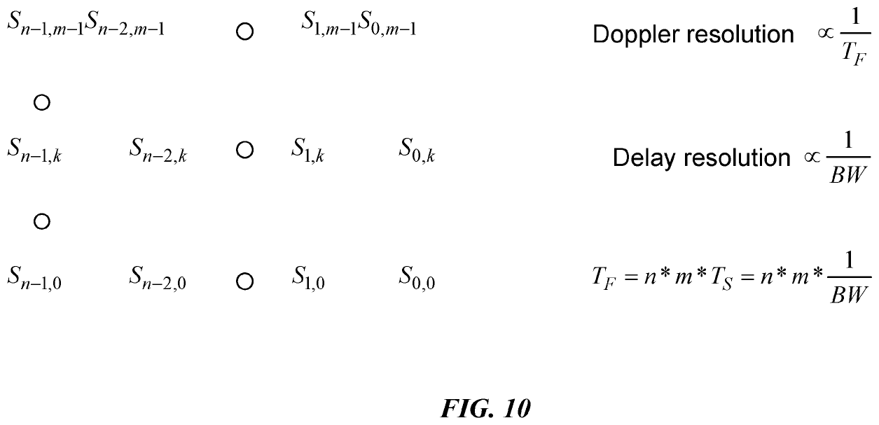

FIG. 10 shows mathematical relationships among various transmission parameters used for generating the OTFS waveform.

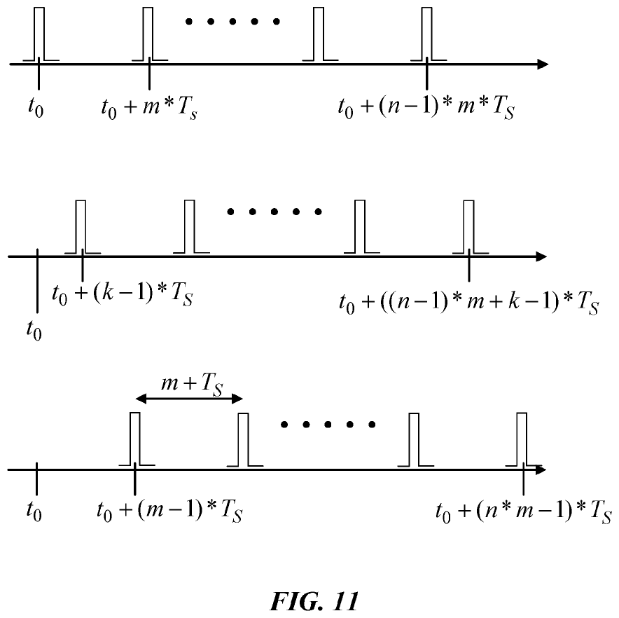

FIG. 11 shows time domain representation of the pulses in an OTFS communication scheme. Starting from the top of the graph, every next row below it shows the that the pulses are shifted in time corresponding to a grid of delay-Doppler resource grid. For the example depicted in FIG. 4, there will be 512 pulse trains (rows) of 16 pulses each, with pulses in each next train shifted from previous pulse by an offset value. Each pulse in a delay-Doppler grid is interpreted as corresponding to a delay-Doppler element with a delay-Doppler coordinate (that, for example, is positioned in the center of the respective delay-Doppler element).

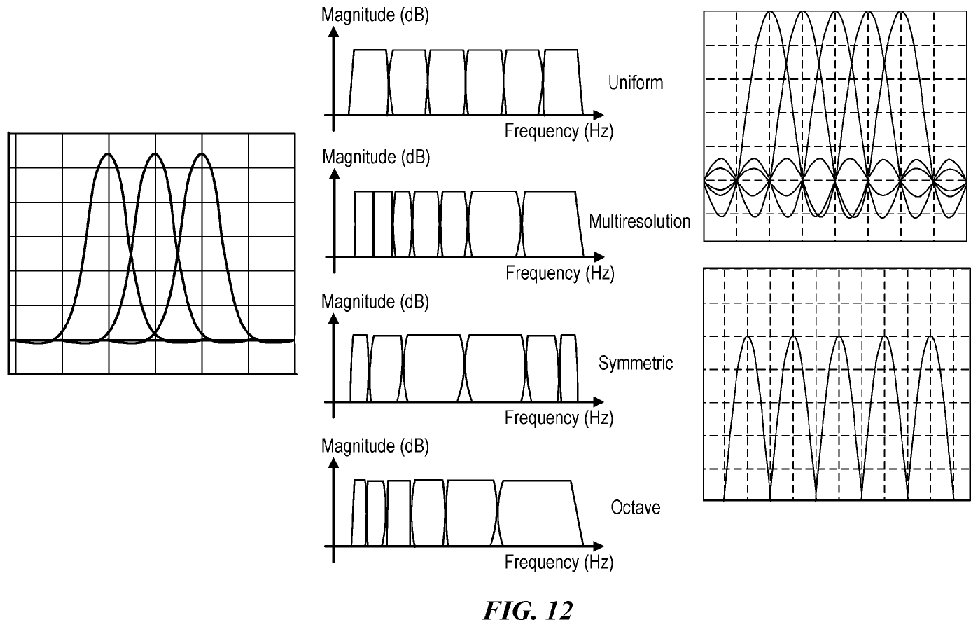

FIG. 12 shows frequency response graphs of filter banks that may be used for generating the output waveform. Various possible filter banks include a uniform filter bank, a multiresolution filter bank, a symmetric filter bank or an octave filter bank. The rightmost graphs show example frequency responses of the filters used by such filter banks.

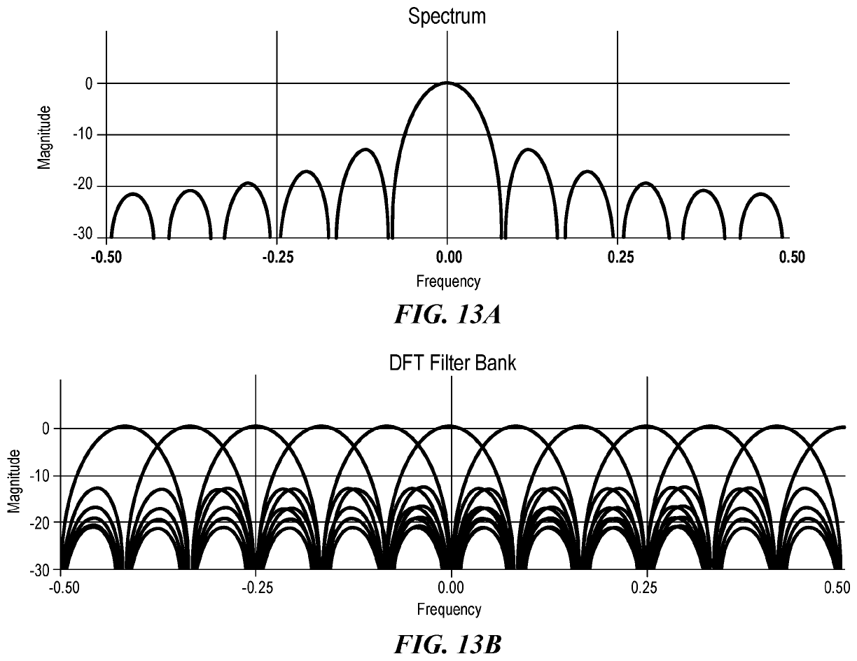

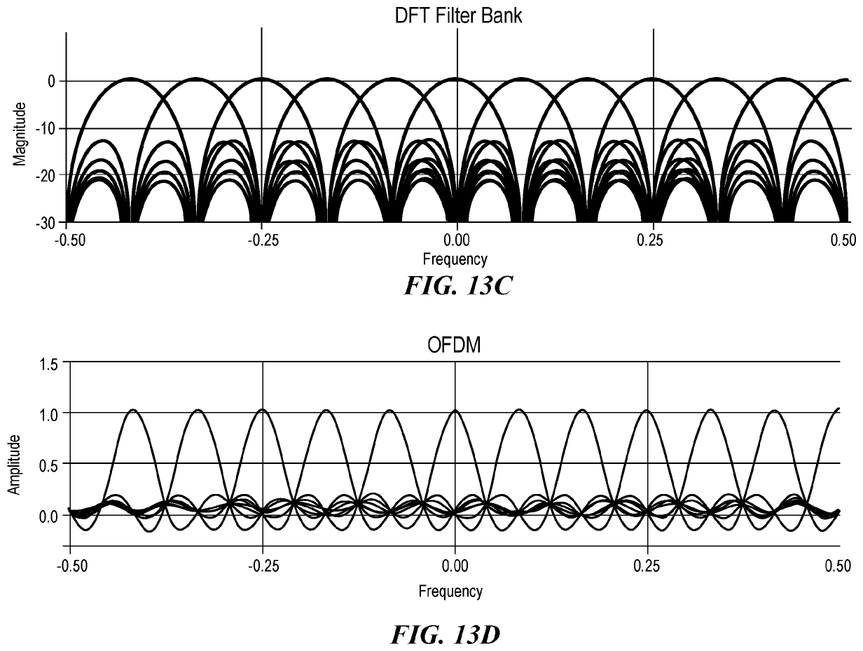

FIG. 13A-13D show examples of frequency responses of filters used for processing a transmission waveform.

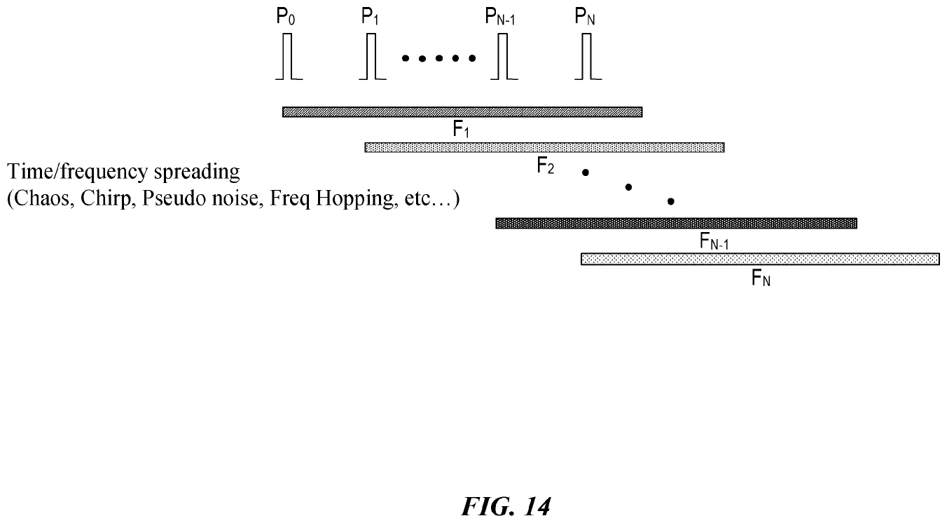

FIG. 14 shows an example of spreading time frequency pulses in frequency domain to generate an output signal that is spread in the frequency domain. The spreading can be done such that the pulses are mapped to non-overlapping frequency bands (bottom arrangement) or over-lapping frequency bands (middle arrangement).

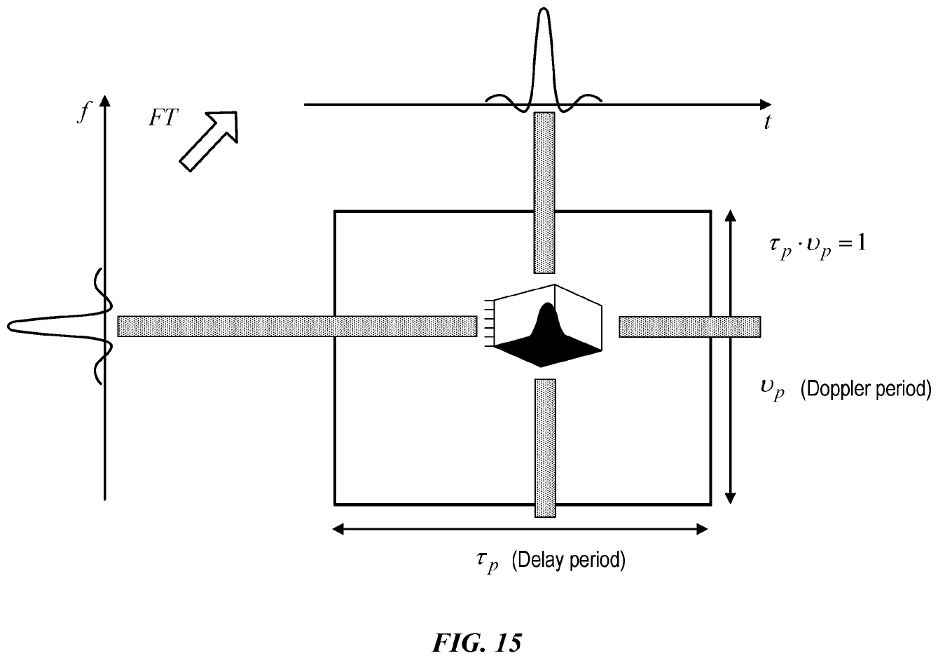

FIG. 15 shows an example of a transmission waveform in delay-Doppler domain. Here, the vertical axis represents frequency and horizontal axis represents time. A conventional pulse that is frequency limited, is not limited in time, while another convention pulse that is time limited, will not be limited in frequency. By contrast, the delay-Doppler pulse, shown in the center, will maintain its 2-D localized shape that remains quasi periodic (same shape, different phase) throughout the delay-Doppler plane.

### 5. OTFS Transmission and Reception

The dimensions of the channel estimation area depend on the expected channel response and its delay and Doppler spreads. Within the channel estimation area, pilot symbols may be placed. A pilot symbol has a known value, and its power may be larger than the other data symbols.

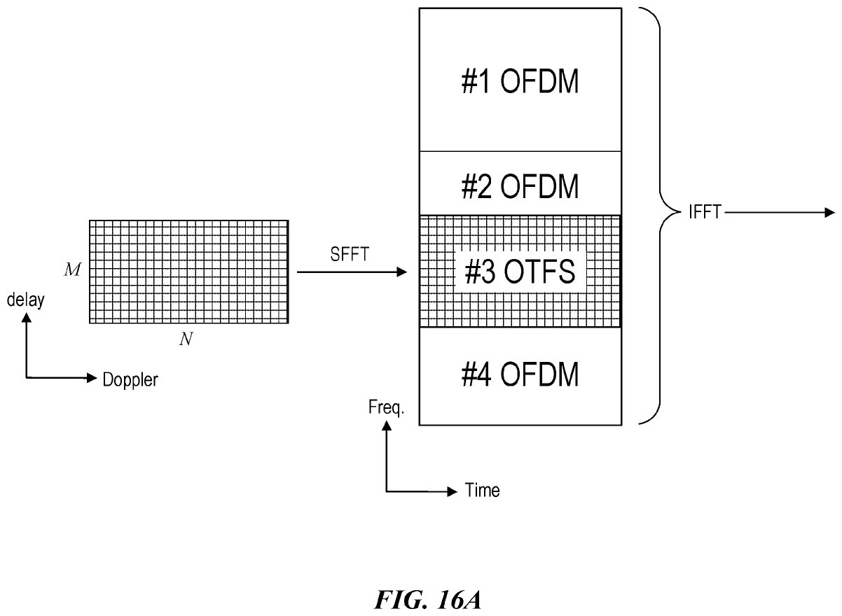

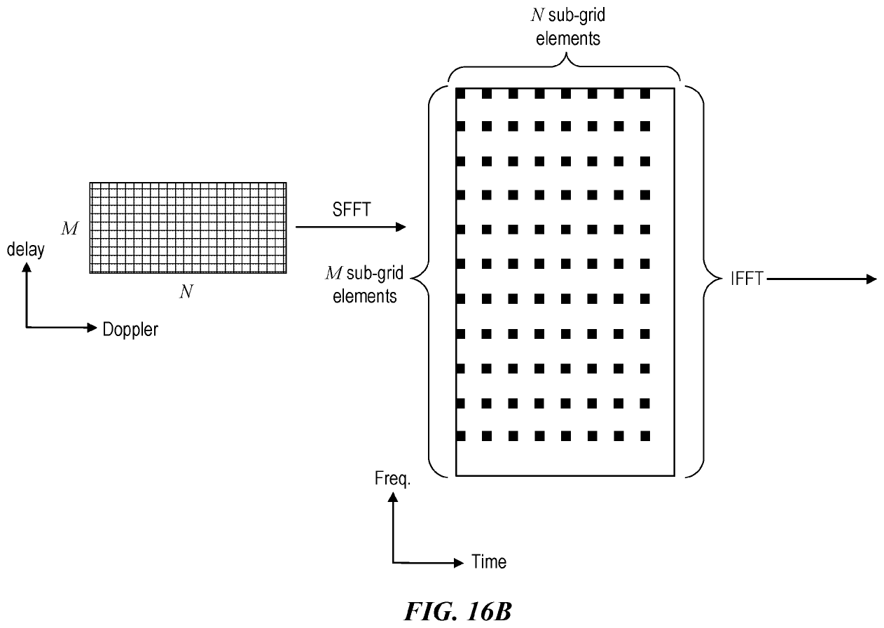

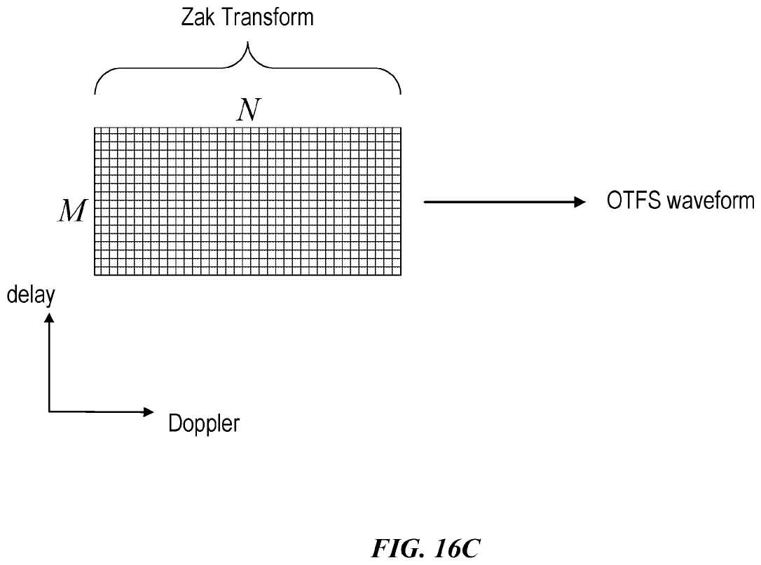

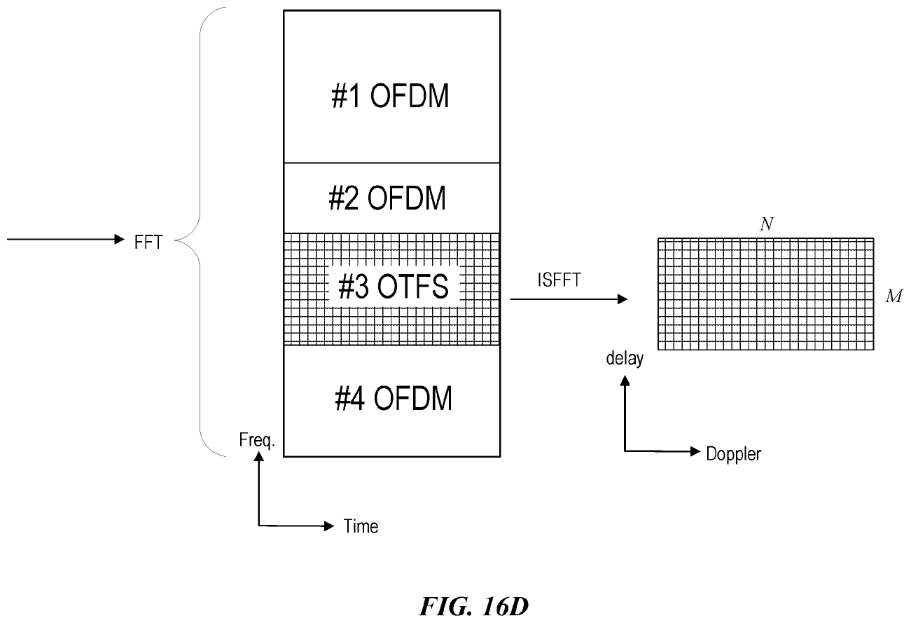

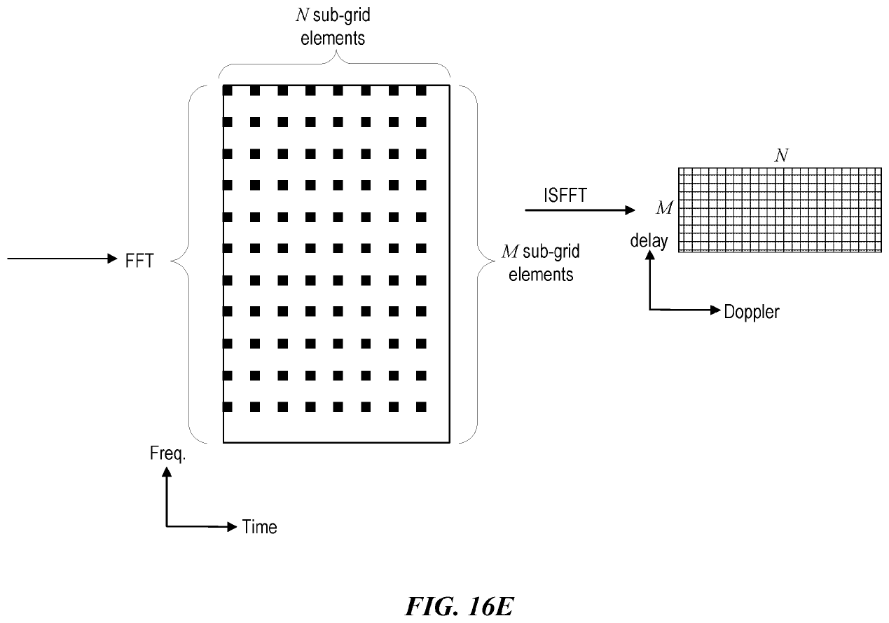

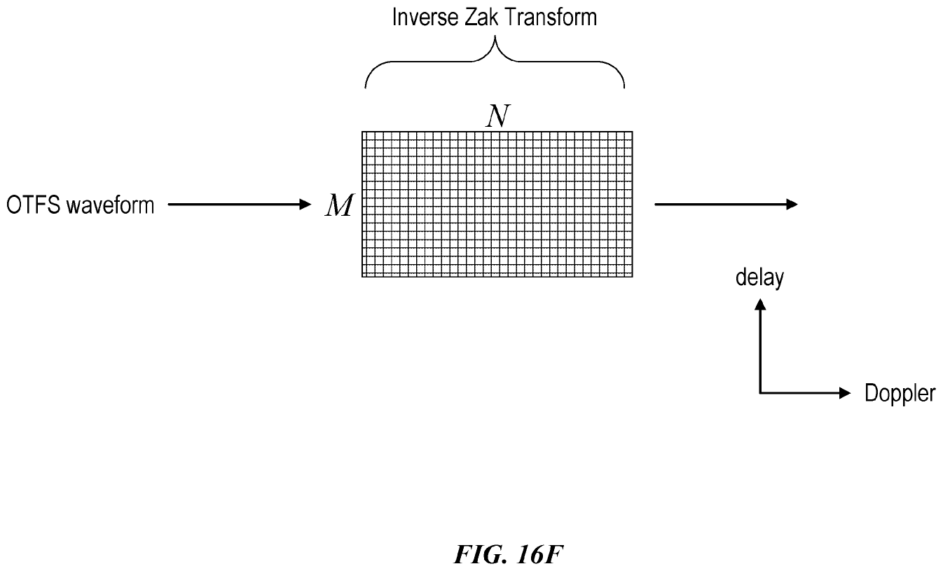

The delay-Doppler grid may be transformed to a transmission waveform in one of the following methods:
1. Transformation to a time-frequency equivalent grid via a discrete Symplectic Fast Fourier Transform (SFFT). This method creates a time-frequency grid, like the one used for OFDM modulation. This OTFS transformed grid may be multiplexed with other time-frequency elements in the OFDM grid, as shown in FIG. 16A, thus allowing multi-user data multiplexing. Then, an OFDM waveform may be generated using an inverse Fourier transform (IFFT) over each OFDM symbol.
2. Transformation to a time-frequency equivalent sub-grid via discrete SFFT, as shown in FIG. 16B. The sub-grid is part of a larger time-frequency grid and has M elements along frequency and N elements along time. Then, an OFDM waveform may be generated using an inverse Fourier transform (IFFT) over each OFDM symbol.
3. Direct transformation to the time domain using a Zak transform over the Doppler dimension of the grid (after extending the grid in a quasi-periodic manner and applying a two-dimensional transmission pulse), as shown in FIG. 16C.

FIG. 16A shows an example of transmission method 1, where a delay-Doppler grid is transformed to a time-frequency grid using a Symplectic Fast Fourier Transform (SFFT). This transformed grid, denoted as “#3 OTFS”, is multiplexed with the data of other OFDM users (denoted as #1, #2 and #4) in the overall OFDM time-frequency grid. An inverse Fast Fourier Transform (IFFT) may be applied to the OFDM symbols to generate the transmission waveform.

FIG. 16B shows an example of transmission method 2, where a delay-Doppler grid is transformed to a time-frequency sub-grid with N elements along the time dimension and M elements along the frequency dimension, using a Symplectic Fast Fourier Transform (SFFT). Note, that the sub-grid may not take all the time-frequency resources and other sub-grids may be also allocated for other delay-Doppler transformations (possibly of different users).

FIG. 16C shows an example of transmission method 3, where a delay-Doppler grid is transformed to an OTFS waveform using the Zak transform over the Doppler dimension. The Zak transform is further discussed in Section 9.

### 6. Examples of Receiver Signal Processing

The received waveform is transformed back to delay-Doppler for further processing. This transformation depends on how the waveform was transmitted:
1. A waveform of transmission method 1, is first transformed to a time-frequency grid using a Fast Fourier Transform (FFT) and then the OTFS section of the grid is extracted and converted to delay-Doppler via the Inverse Symplectic Fast Fourier Transform (ISFFT). An example for this is given in FIG. 16D.
2. A waveform of transmission method 2, is first transformed to a time-frequency grid using a Fast Fourier Transform (FFT) and then the OTFS sub-grid is extracted and converted to delay-Doppler via the Inverse Symplectic Fast Fourier Transform (ISFFT). An example for this is given in FIG. 16E.
3. A waveform of transmission method 3, is transformed directly to delay-Doppler via an inverse Zak transform over the time dimension, as shown in FIG. 16F. Afterwards, a receive two-dimensional pulse may be applied to it.

FIG. 16D depicts a receiver processing example for a waveform generated by transmission method 1. The received waveform is transformed to a time-frequency grid using a Fast Fourier Transform (FFT) and the OTFS part (denoted as “#3 OTFS”) is extracted and transformed to delay-Doppler via an Inverse Symplectic Fast Fourier Transform (ISFFT).

FIG. 16E depicts a receiver processing example for a waveform generated by transmission method 2. The received waveform is transformed to a time-frequency grid using a Fast Fourier Transform (FFT) and the OTFS sub-grid is extracted and transformed to delay-Doppler via an Inverse Symplectic Fast Fourier Transform (ISFFT).

FIG. 16F depicts a receiver processing example for a waveform generated by transmission method 3. The received OTFS waveform is arranged in a grid N×M elements and transformed to delay-Doppler via the inverse Zak transform over the time dimension. It is noted that in the description of UWB OTFS signal generation and reception as described in the present document, while reference signals are not specifically described, in practical systems, some resources may be allocated to various reference signals for monitoring or calibration of the channel between a transmitter and a receiver.

### 7. Advantageous Benefits of the UWB Waveform

One operational advantage for the embodiments that use the UWB signal waveform for transmission/reception of information as described herein is that significant processing gain may be achieved over conventional wireless data transmission techniques. For example, spectral energy in any given frequency spectrum may be sufficiently low, allowing for higher link budget for the transmission scheme. In additional, due to the spread spectrum nature of the signal over the wireless medium, some embodiments may be able to benefit from low possibility of interception or jamming, compared to conventional OTFS transmission schemes.

### 8. Advantageous Benefits of the Filter Bank Approach

As described with reference to, for example, FIGS. 12 and FIGS. 13A-13D, the time domain pulse train or sequence underlying the transmitted signal waveform may be shaped through filters of differing (or uniform) bandwidths. One advantageous aspect of such a scheme is that the differing filter bandwidth may be used for shaping pulses along Doppler dimension. The filter through which a particular data of a particular user is processed may be determined during run-time and adjusted based on operational needs. Another advantageous aspect of using filter banks is that the output signal of each filter will typically have a peak to average power ration (PAPR) that is significantly less than the PAPR of the entire signal if it were transmitted using a conventional transmission scheme. In particular, filter bank resolution in the Doppler domain may be used to not only control PAPR, but also used for adjusting Doppler resolution of received signals at a receiver during operation. For example, signals for a transmitter user that is not moving may be processed through a wide filter with low PAPR value. Conversely, a relatively narrower filter may be used in a case that a finer Doppler resolution is desired. The exact transmit/receiver filter bandwidths used for a signal communication between a transmitter and a receiver may be communicated ahead of time and may be adjusted or switched from time to time based on run-time conditions.

As an illustration of the above advantageous aspect, referring back to FIG. 4, a row 404 of a particular Doppler value will typically have signals with same amplitude, which lends itself to low PAPR signals after the mapping into an OTFS waveform is performed. User data may be multiplexed to assign data of one user to a row, thereby benefitting from the low PAPR. Furthermore, the corresponding channel acquisition may be extended over a longer duration (e.g., 10 milliseconds instead of 1 millisecond) to obtain a fine estimate at the specific Doppler shift value.

### 9. Examples Embodiments of the Zak Transform

Signal transmissions in a wireless network may be represented by describing the waveforms in the time domain, in the frequency domain, or in the delay-Doppler domain (e.g., Zak domain). Because these three represent three different ways of describing the signals, signal in one domain can be converted into signal in the other domain via a transform. For example, a time-Zak transform may be used to convert from Zak domain to time domain. For example, a frequency-Zak transform may be used to convert from the Zak domain to the frequency domain. For example, the Fourier transform (or its inverse) may be used to convert between the time and frequency domains.

In signal processing, it is traditional to represent signals (or waveforms) either in time or in the frequency domain. Each representation reveals different attributes of the signal. The dictionary between these two realizations is the Fourier transform:

$$FT : {L}_{2} ( t ∈ ℝ ) \to {L}_{2} ( f ∈ ℝ )$$

Interestingly, there is another domain where signals can be naturally realized. This domain is called the delay Doppler domain. For the purpose of the present discussion, this is also referred to as the Zak domain. In its simplest form, a Zak signal is a function φ(τ, v) of two variables. The variable τ is called delay and the variable v is called Doppler. The function φ(τ, v) is assumed to be periodic along v with period and vᵣ quasi-periodic along τ with period τᵣ. The quasi periodicity condition is given by:

$$φ ( τ + n {τ}_{r 1} v + {mv}_{r} ) = exp ( j 2 π nv \cdot {τ}_{r} ) φ ( τ , v ) ,$$

for every n, m∈ [symbol] .

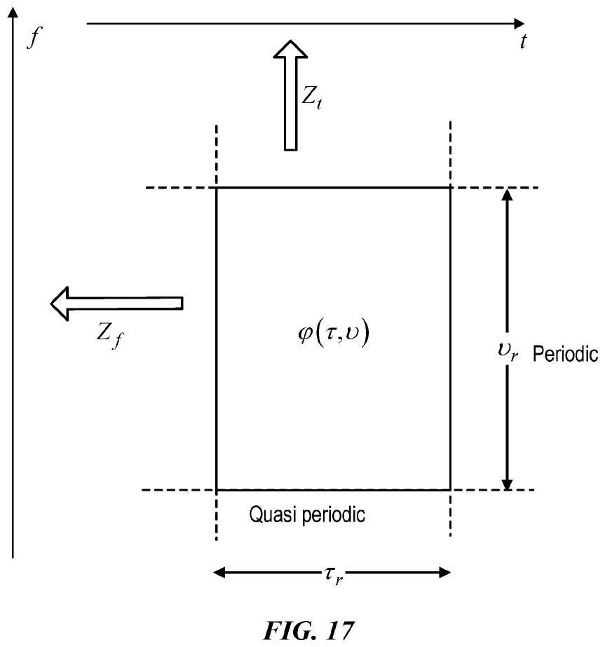

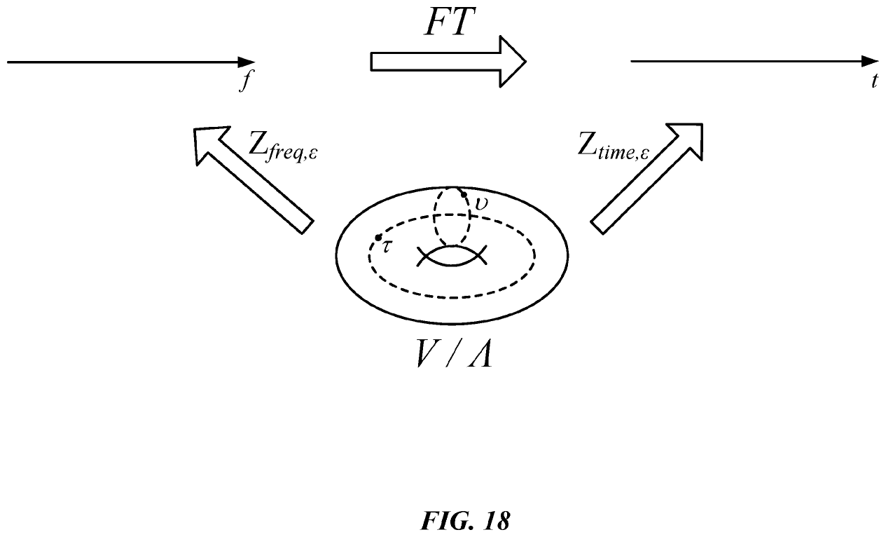

The periods are assumed to satisfy the Nyquist condition τᵣ·vᵣ=1. Zak domain signals are related to time and frequency domain signals through canonical transforms that are called the time and frequency Zak transforms. The time and frequency Zak transforms are principally geometric projections: the time Zak transform is integration along the Doppler variable and reciprocally the frequency Zak transform is integration along the delay variable. The different signal domains and the transformations connecting between them are depicted in FIG. 17.

The Zak transform plays for OTFS the same role the Fourier transform plays for OFDM. For example, the time Zak transform is integration along the Doppler dimension (taking the DC component) for every point of time. Reciprocally, the frequency Zak transform is Fourier transform along the delay dimension. In other words, the pair of Zak trans-forms constitute a square root decomposition of the Fourier transform, reinforcing the interpretation of the Zak realization as residing between the time and the frequency realizations (see FIG. 18).

### 10. Example Embodiments of the Disclosed Technology

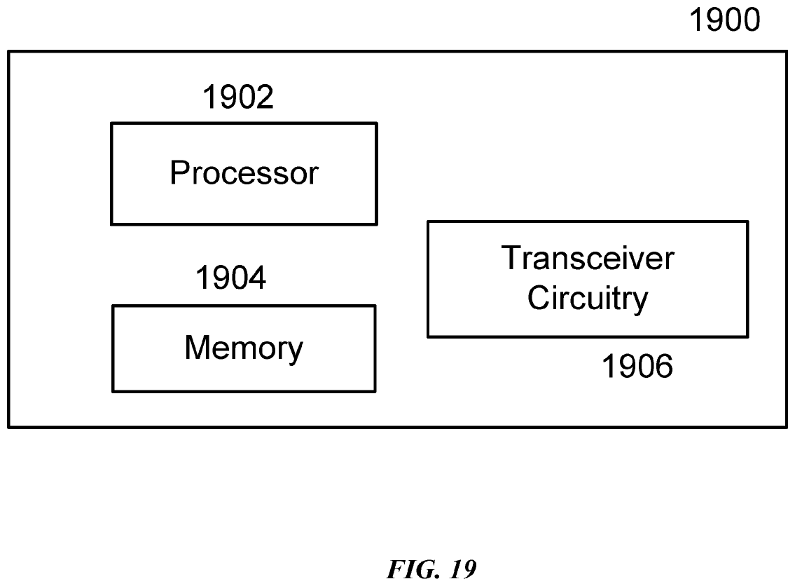

FIG. 19 is a block diagram representation of a wireless hardware platform 1900 which may be used to implement the various methods described in the present document. The hardware platform 1900 may be incorporated within a base station or a user device. The hardware platform 1900 includes a processor 1902, a memory 1904 and a transceiver circuitry 1906. The processor may execute instructions, e. g., by reading from the memory 1904, and control the operation of the transceiver circuitry 1906 and the hardware platform 1900 to perform the methods described herein. In some embodiments, the memory 1904 and/or the transceiver circuitry 1906 may be partially or completely contained within the processor 1902 (e.g., same semiconductor package).

The following examples highlight some embodiments that use one or more of the techniques described herein.

The following solutions may be preferably implemented by some transmitter embodiments.

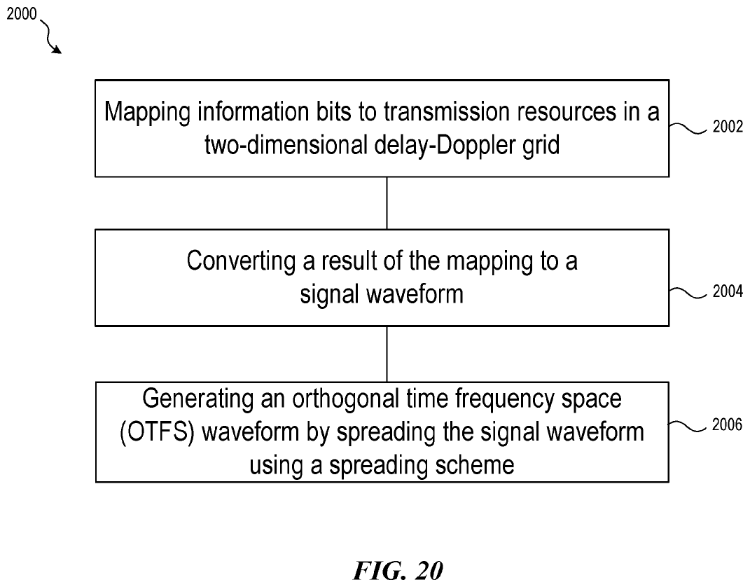

1. A method of wireless communication (e.g., method 1900 shown in FIG. 20), comprising: mapping (2002) information bits to transmission resources in a two-dimensional delay-Doppler grid, wherein the two-dimensional delay-Doppler grid comprises N Doppler elements along a Doppler dimension and M delay elements along a delay dimension, where N and M are positive integers; converting (2004) a result of the mapping to a signal waveform; and generating (2006) an orthogonal time frequency space (OTFS) waveform by spreading the signal waveform using a spreading scheme. In some embodiments, the signal waveform may not be explicitly generated and the OTFS waveform may by directly generated without the intermediate step of generating the signal waveform.

2. The method of solution 1, wherein the signal waveform comprises sequences of pulses that are modulated using a complex waveform depending on a coordinate of the Doppler element of a corresponding pulse.

3. The method of any of solutions 1-2, wherein time domain positions of pulses in the sequences of pulses are shifted along time dimension depending on a coordinate of the delay element of the corresponding pulse. Some examples are depicted with respect to FIGS. 2, 15 and 9B.

4. The method of any of solutions 1-3, wherein the OTFS waveform corresponds to an output of exciting a two-dimensional filter in the delay-Doppler domain using the transmission resources. Various examples of two-dimensional filters are described with respect to FIGS. 12 and 13A-13D.

5. The method of any of solutions 1-4, wherein the spreading scheme comprises applying a chirp function to each pulse.

6. The method of any of solutions 1-4, wherein the spreading scheme comprises applying a chaos-based transformation.

7. The method of any of solutions 1-4, wherein the spreading scheme comprises applying a pseudo noise modulation.

8. The method of any of solutions 1-4, wherein the spreading scheme comprises applying frequency hopping.

Additional details related to the spreading schemes in solutions 5-8 are discussed with reference to FIG. 9.

9. The method of any of solutions 1-8, wherein the two-dimensional filter comprises a uniform filter bank.

10. The method of any of solutions 1-8, wherein the two-dimensional filter comprises a non-uniform filter bank.

11. The method of solution 10, wherein the non-uniform filter bank comprises a wavelet filter bank.

Additional details related to the filter banks in solutions 9-11 are discussed with reference to FIGS. 10, 13, 14A-14D and Section 8.

12. The method of any of solutions 1-8, wherein the two-dimensional filter comprises a discrete Fourier transform.

13. The method of any of solutions 1-12, wherein the two-dimensional filter uses filters of differing bandwidth. Additional details are discussed with reference to FIGS. 13, 14A-14D and Sections 7 and 8.

14. The method of any of solutions 1-9, wherein the sequence of pulses is mapped to overlapping frequency bands in the signal waveform. Additional examples are described with respect to FIG. 15.

15. The method of solutions 1-4, wherein the spreading is performed in the time domain and/or the frequency domain.

16. The method of any of solutions 1-4, wherein the mapping the information bits to the two-dimensional delay-Doppler grid comprises multiplexing user data for multiple users and mapping to the delay-Doppler grid.

17. The method of solution 16, wherein the multiplexing is performed along the delay dimension, the Doppler dimension, and/or a spatial dimension.

18. The method of solution 16-17, wherein the multiplexing is performed using code division multiplexing. For example, code division multiplexing access (CDMA) based multiplexing of users may be used in some embodiments.

19. The method of any of solutions 1-18, wherein the converting the result of the mapping to the signal waveform comprises applying a Symplectic Fast Fourier Transform (SFFT).

20. The method of any of solutions 1-18, wherein the converting the result of the mapping to the signal waveform comprises applying a Zak transform over the Doppler dimension. Additional details related to the Zak transform are discussed in Section 9.

The following solutions may be preferably implemented by some receiver embodiments. It is noted that the receiver-side techniques follow a symmetrical receiver-side processing for receiving transmitted signal and accordingly similar technical terms are used in describing these embodiments. Furthermore, while the drawings described in the present document often show transmitter-side signal processing, the corresponding inverse processing will be performed by a receiver of a signal generated by a transmitter according to the disclosed techniques.

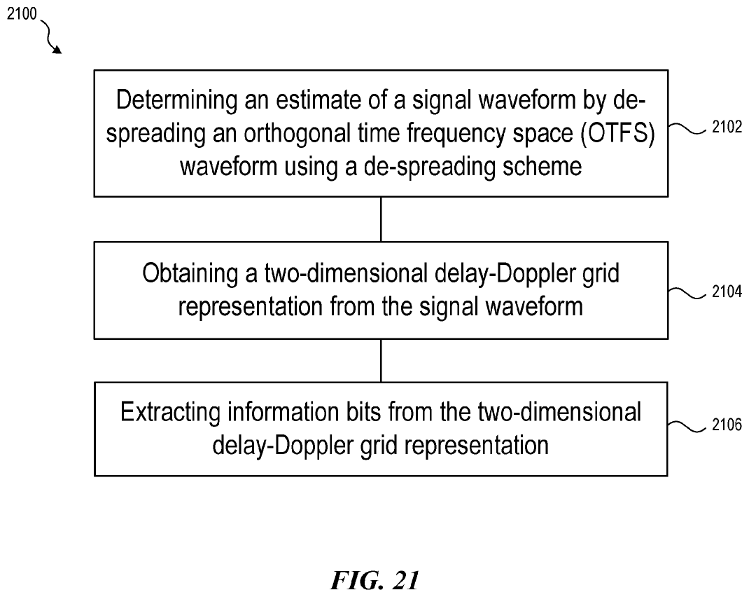

21. A method of wireless communication (e.g., method 2100 depicted in FIG. 21), comprising: determining (2102) an estimate of a signal waveform received at a receiver by de-spreading an orthogonal time frequency space (OTFS) waveform using a de-spreading scheme; obtaining (2104) a two-dimensional delay-Doppler grid representation from the signal waveform; and extracting (2106) information bits from the two-dimensional delay-Doppler grid representation.

22. The method of solution 21, wherein the signal waveform comprises sequences of pulses that are modulated using a complex waveform depending on a coordinate of the Doppler element of a corresponding pulse.

23. The method of any of solutions 21-22, wherein time domain positions of pulses in the sequences of pulses are shifted along time dimension depending on a coordinate of the delay element of a corresponding pulse.

24. The method of any of solutions 21-23, wherein the OTFS waveform corresponds to an output of exciting a two-dimensional filter in the delay-Doppler domain using the transmission resources.

25. The method of any of solutions 21-24, wherein the de-spreading scheme comprises applying an inverse chirp function to the received signal waveform.

26. The method of any of solutions 21-24, wherein the de-spreading scheme comprises applying an inverse chaos-based transformation to the received signal waveform.

27. The method of any of solutions 21-24, wherein the de-spreading scheme comprises applying a pseudo noise demodulation to the received signal waveform.

28. The method of any of solutions 21-24, wherein the de-spreading scheme comprises applying an inverse frequency hopping to the received signal waveform.

29. The method of any of solutions 21-28, wherein the two-dimensional filter comprises a uniform filter bank.

30. The method of any of solutions 21-28, wherein the two-dimensional filter comprises a non-uniform filter bank.

31. The method of solution 30, wherein the non-uniform filter bank comprises a wavelet filter bank.

32. The method of any of solutions 21-28, wherein the two-dimensional filter comprises an inverse discrete Fourier transform.

33. The method of any of solutions 21-32, wherein the two-dimensional filter uses filters of differing bandwidth.

34. The method of any of solutions 21-29, wherein the sequence of pulses is mapped to overlapping frequency bands in the signal waveform.

35. The method of solutions 21-24, wherein the de-spreading is performed in the time domain and/or the frequency domain.

36. The method of any of solutions 21-24, wherein the de-mapping the information bits from the two-dimensional delay-Doppler grid comprises demultiplexing user data from multiplexed data for multiple users and demapping from the delay-Doppler grid.

37. The method of solution 35, wherein the demultiplexing is performed along the delay dimension, the Doppler dimension, and/or a spatial dimension.

38. The method of solution 35-36, wherein the demultiplexing is performed using code division demultiplexing.

39. The method of any of solutions 21-38, wherein the converting the result of the demapping to the estimate of the signal waveform comprises applying an inverse Symplectic Fast Fourier Transform (SFFT).

40. The method of any of solutions 21-38, wherein the converting the result of the demapping to the estimate of the signal waveform comprises applying an inverse Zak transform over the Doppler dimension.

41. The method of any of above solutions, wherein the signal waveform comprises an ultra-wide band (UWB) signal.

42. A wireless communication apparatus comprising a processor and a transceiver, wherein the processor is configured to perform a method recited in any one or more of above solutions.

43. A system comprising a plurality of wireless communication apparatus, each apparatus comprising one or more processors, configured to implement a method recited in any one or more of above solutions.

44. A technique, method or apparatus disclosed in the present document.

In the solutions provided in the present document, information bits may include user data, control data or other network traffic that is communicated between a transmitting device and a receiver device. The various embodiments have been described with M=512 and N=16, but other values of N and M are possible in implementations.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
mapping information bits to transmission resources in a two-dimensional delay-Doppler grid, wherein the two-dimensional delay-Doppler grid comprises N Doppler elements and M delay elements, where N and M are positive integers;
converting a result of the mapping to a signal waveform; and
generating an orthogonal time frequency space (OTFS) waveform by spreading the signal waveform using a spreading scheme.

2. The method of claim 1, wherein the signal waveform comprises sequences of pulses that are modulated using a complex waveform depending on a coordinate of the Doppler element of a corresponding pulse.

3. The method of claim 2, wherein time domain positions of pulses in the sequences of pulses are shifted along time dimension depending on a coordinate of the delay element of the corresponding pulse.

4. The method of claim 1, wherein the OTFS waveform corresponds to an output of exciting a two-dimensional filter in the delay-Doppler domain using the transmission resources.

5. The method of claim 1, wherein the spreading scheme comprises applying a chirp function to each pulse, applying a chaos-based transformation, applying a pseudo noise modulation, or applying frequency hopping.

6-13. (canceled)

14. The method of claim 2, wherein the sequence of pulses is mapped to overlapping frequency bands in the signal waveform.

15. (canceled)

16. The method of claim 1, wherein the mapping the information bits to the two-dimensional delay-Doppler grid comprises multiplexing user data for multiple users and mapping to the delay-Doppler grid.

17. The method of claim 16, wherein the multiplexing is performed along the delay dimension, the Doppler dimension, or a spatial dimension.

18. The method of claim 16, wherein the multiplexing is performed using code division multiplexing.

19. The method of claim 1, wherein the converting the result of the mapping to the signal waveform comprises applying a Symplectic Fast Fourier Transform (SFFT).

20. The method of claim 1, wherein the converting the result of the mapping to the signal waveform comprises applying a Zak transform over the Doppler dimension.

21-43. (canceled)

44. An apparatus for wireless communication, comprising a processor configured to implement:
mapping information bits to transmission resources in a two-dimensional delay-Doppler grid, wherein the two-dimensional delay-Doppler grid comprises N Doppler elements and M delay elements, where N and M are positive integers;
converting a result of the mapping to a signal waveform; and
generating an orthogonal time frequency space (OTFS) waveform by spreading the signal waveform using a spreading scheme.

45. The apparatus of claim 44, wherein the signal waveform comprises sequences of pulses that are modulated using a complex waveform depending on a coordinate of the Doppler element of a corresponding pulse.

46. The apparatus of claim 45, wherein time domain positions of pulses in the sequences of pulses are shifted along time dimension depending on a coordinate of the delay element of a corresponding pulse.

47. The apparatus of claim 44, wherein the OTFS waveform corresponds to an output of exciting a two-dimensional filter in a delay-Doppler domain using the transmission resources.

48. The apparatus of claim 44, wherein the spreading scheme comprises applying a chirp function to each pulse, applying a chaos-based transformation, applying a pseudo noise modulation, or applying frequency hopping.

49. The apparatus of claim 45, wherein the sequence of pulses is mapped to overlapping frequency bands in the signal waveform.

50. The apparatus of claim 44, wherein the mapping the information bits to the two-dimensional delay-Doppler grid comprises multiplexing user data for multiple users and mapping to the delay-Doppler grid.

51. The apparatus of claim 50, wherein the multiplexing is performed along a delay dimension, a Doppler dimension, or a spatial dimension.

52. The apparatus of claim 50, wherein the multiplexing is performed using code division multiplexing.

53. The apparatus of claim 44, wherein the converting the result of the mapping to the signal waveform comprises applying a Symplectic Fast Fourier Transform (SFFT).
